(19) United States
(12) Patent Application Publication
(10) Pub. No.: US 2003/0041275 A1
(43) Pub. Date: Feb. 27, 2003

(54) Semiconductor integrated circuit device

(75) Inventors: Shigeru Nishio, Kawasaki (JP); Tsutomu Ohtsu, Kawasaki (JP); Tatsuya Fukazawa, Kawasaki (JP); Hirokazu Tanaka, Kawasaki (JP); Masayasu Hojo, Kawasaki (JP); Satoshi Masuda, Kawasaki (JP); Yoriko Matuura, Kawasaki (JP); Toshiaki Sakai, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 10/100,024

(22) Filed: Mar. 19, 2002

(30) Foreign Application Priority Data
Aug. 21, 2001 (JP) 2001-249828

(51) Int. Cl. G06F 1/12

(52) U.S. Cl. 713/400

(57) ABSTRACT

The invention relates to semiconductor integrated circuit devices having a circuit operating in synchronism with a clock signal, and it is an object of the invention to provide a semiconductor integrated circuit device in which clock skew between lines that occurs as a result of a change in the circuit layout of the LSI can be easily optimized. There is provided a configuration including an inverter of a clocked circuit formed on a silicon substrate and operating in synchronism with a clock signal, an inverter of a clock timing adjusting circuit formed in an SOI structure, and a via hole for electrically connecting the inverters.

### BACKGROUND OF THE INVENTION

1. Field of the Invention

The present invention relates to a semiconductor integrated circuit device having a circuit that operates in synchronism with a clock signal.

2. Description of the Related Art

A system LSI (large scale integrated circuit) includes circuit blocks (macros) having predetermined functions such as a RAM (random access memory) and a DSP (digital signal processor) and sequential circuits such as a flip-flop circuit (hereinafter referred to as “clocked circuits”). A clocked circuit operates in synchronism with a clock signal input thereto.

A delay or rounding can occur in a clock signal depending on the line length of the clock signal line. A relative deviation between phases of a clock signal that occurs at clock input terminals of clocked circuits because of a delay of the clock signal is referred to as “clock skew”. Clock skew must be reduced to cause a clocked circuit to operate in synchronism with a clock signal.

In general, a circuit layout of a system LSI is designed as follows. First, clocked circuits and the like are provided in predetermined positions. Next, clock signal lines connected to clock input terminals of the clocked circuits are provided.

FIG. 10 shows an example of a configuration of sequential circuits and clock signal lines provided using a clock tree generating tool. As shown in FIG. 10, clock signal lines 112 through 115 are respectively connected to clock input terminals of a plurality of FF circuits 102 through 105 with different line lengths.

When the clock signal lines 112 through 115 with a small line width achieved by recent fine processing techniques have large line lengths, buffers are preferably inserted at predetermined intervals to reduce a delay time of a clock pulse. For this purpose, a buffer 109 is inserted in the clock signal line 115 having a line length longer than those of the other lines to reduce a delay time of a clock pulse and to prevent the rounding of the clock pulse. A predetermined number of gate-delaying buffers 109 are inserted in the other clock signal lines 112 through 114 to adjust clock skew between the FF circuits 102 through 105.

As thus described, clock timing adjusting elements such as the buffer 109 and inverters that form a clock timing adjusting circuit are inserted to adjust a delay or rounding of a clock pulse and to adjust the line lengths of the clock signal lines 112 through 115 and the number of inputs of a logic gate (fanouts) provided downstream thereof, which provides an effect of reducing clock skew.

When the clock timing adjusting circuit formed by the buffer 109, inverters, and so on is inserted in the clock signal lines 112 through 115, a change must be made in the circuit layout to accommodate the newly provided clock timing adjusting circuit. Since the line lengths of the clock signal lines 112 through 115 are changed as a result of the change in the circuit layout, there will be a need for checking whether each clocked circuit operates in synchronism with a clock signal. When each clocked circuit does not operate in synchronism with a clock signal, clock timing is adjusted again through the same steps as those described above to reduce clock skew.

However, since a recent LSI is formed by a very great number of clocked circuits, the above-described steps must be repeated in order to optimize the circuit configuration. This results in a problem in that a long time is spent before manufacture in finalizing the circuit configuration to result in an increase in the designing cost.

### SUMMARY OF THE INVENTION

It is an object of the invention to provide a semiconductor integrated circuit device in which it is possible to easily optimize clock skew between lines that occurs as a result of a change in the circuit configuration of the LSI.

The above-described object is achieved by a semiconductor integrated circuit device that is characterized in that it has a clocked circuit formed on a substrate and operating in synchronism with a clock signal and a clock timing adjusting circuit formed in a layer different from the layer in which the clocked circuit is formed.

### BRIEF DESCRIPTION OF THE DRAWINGS

FIG. 1 is a circuit diagram of a semiconductor integrated circuit device according to a first embodiment of the invention;

FIG. 2 is a sectional view showing a configuration of the semiconductor integrated circuit device according to the first embodiment of the invention;

FIG. 3 illustrates a configuration of the semiconductor integrated circuit device according to the first embodiment of the invention;

FIG. 4 illustrates a modification of the configuration of the semiconductor integrated circuit device according to the first embodiment of the invention;

FIG. 5 is a sectional view showing a configuration of a semiconductor integrated circuit device according to a second embodiment of the invention;

FIG. 6 illustrates the configuration of the semiconductor integrated circuit device according to the second embodiment of the invention;

FIG. 7 illustrates a modification of the configuration of the semiconductor integrated circuit device according to the second embodiment of the invention;

FIG. 8 illustrates another modification of the configuration of the semiconductor integrated circuit device according to the second embodiment of the invention;

FIG. 9 illustrates still another modification of the configuration of the semiconductor integrated circuit device according to the second embodiment of the invention; and

FIG. 10 illustrates a conventional method for designing a circuit layout.

### DETAILED DESCRIPTION OF THE PREFERRED EMBODIMENTS

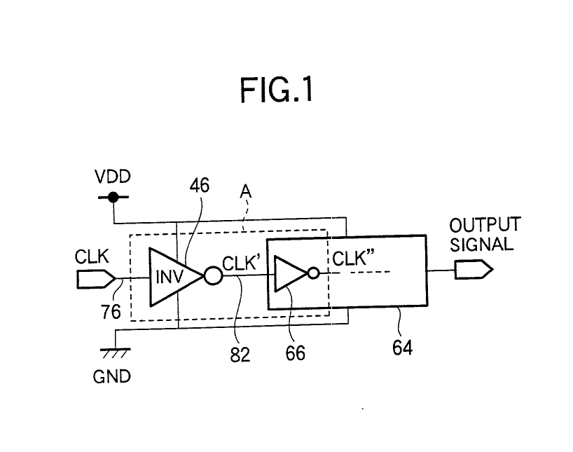

A semiconductor integrated circuit device according to a first embodiment of the invention will now be described with reference to FIGS. 1 through 4. FIG. 1 is a circuit diagram showing a part of the semiconductor integrated circuit device of the present embodiment. As shown in FIG. 1, a clock signal CLK is input to an inverter (INV) 46 of a clock timing adjusting circuit. An output terminal of the inverter 46 is connected to an input terminal of an FF circuit 64 of a clocked circuit. A predetermined output signal is output from an output terminal of the FF circuit 64. A predetermined driving voltage VDD is applied to the inverter 46 and FF circuit 64. The FF circuit 64 is formed by a plurality of elements such as an inverter 66.

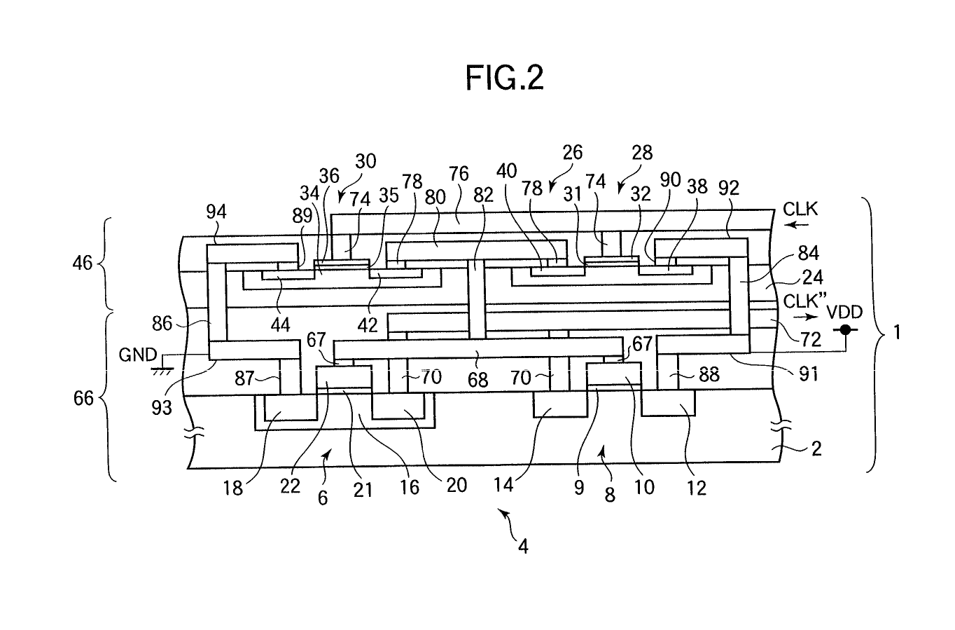

FIG. 2 is a sectional view showing a schematic configuration of the region A enclosed by a broken line in the circuit diagram of FIG. 1. As shown in FIG. 2, a semiconductor chip 1 has a bulk CMOS 4 that constitutes the inverter 66 of the FF circuit 64 and an SOI-CMOS 26 that constitutes the inverter 46 of the clock timing adjusting circuit formed in an SOI (silicon-on-insulator) film on the bulk CMOS 4.

The bulk CMOS 4 is formed on an n-type silicon (Si) substrate 2. The bulk CMOS 4 is formed with a p-channel MOSFET 8 located on the right side of the figure and an n-channel MOSFET 6 located on the left side of the figure. The p-channel MOSFET 8 has a gate insulation film 9 formed on the silicon substrate 2 and a gate electrode 10 formed on the gate insulation film 9. A p-type source region 12 in which a p-type impurity is diffused is formed on the right of the gate electrode 10 in the FIGURE in the vicinity of the surface of the silicon substrate 2, and a p-type drain region 14 in which a p-type impurity is diffused is formed on the left of the gate electrode 10 in the FIGURE.

The n-channel MOSFET 6 is formed in a p-type region (p-well) 16 formed in the vicinity of the surface of the silicon substrate 2. A gate insulation film 21 is formed on the p-well 16, and a gate electrode 22 is formed on the gate insulation film 21. An n-type drain region 20 in which an n-type impurity is diffused is formed on the right of the gate electrode 22 in the FIGURE in the vicinity of the surface of the p-well 16, and an n-type source region 18 in which an n-type impurity is diffused is formed on the left of the gate electrode 22 in the FIGURE.

The gate electrodes 10 and 22 are electrically connected to each other through a connecting conductor and line 68 in via holes 67 that are formed by removing an insulation film on each of the gate electrodes 10 and 22. The inverter 66 is thus formed. The drain regions 14 and 20 are electrically connected to each other through a connecting conductor and line 72 in via holes 70 that are formed by removing an insulation film on the drain regions 14 and 20 to output a clock signal CLK″ having a waveform that is the inverse of the waveform of a clock signal CLK′ input from the inverter 46. The predetermined driving voltage VDD is applied to the source region 12 through a connecting conductor and line 91 in a via hole 88 formed by removing an insulation film on the source region 12. The source region 18 is connected to the ground (GND) through a connecting conductor and line 93 in a via hole 87 formed by removing an insulation film on the source region 18.

The surface of an insulation film on the top of the inverter 66 is planarized by polishing the same using CMP (chemical mechanical polishing) or the like. An n-type single crystal silicon layer 24 in which an n-type impurity is diffused is formed on the insulation film. The SOI-CMOS 26 is formed on the single crystal silicon layer 24. The SOI-CMOS 26 has a p-channel MOSFET 28 that is located on the right side of the figure and an n-channel MOSFET 30 that is located on the left side of the figure.

The p-channel MOSFET 28 has agate insulation film 31 formed on the single crystal silicon layer 24 and a gate electrode 32 formed on the gate insulation film 31. A p-type source region 38 in which a p-type impurity is diffused is formed on the right of the gate electrode 32 in the figure in the vicinity of the surface of the single crystal silicon layer 24, and a p-type drain region 40 in which a p-type impurity is diffused is formed on the left of the gate electrode 32 in the figure.

The n-channel MOSFET 30 is formed in a p-well 34 that is formed in the vicinity of the surface of the single crystal silicon layer 24. A gate insulation film 35 is formed on the p-well 34, and a gate electrode 36 is formed on the gate insulation film 35. An n-type drain region 42 in which an n-type impurity is diffused is formed on the right of the gate electrode 36 in the figure in the vicinity of the surface of the p-well 34, and an n-type source region 44 in which an n-type impurity is diffused is formed on the left of the gate electrode 22 in the figure.

The gate electrodes 32 and 36 are electrically connected to each other through a connecting conductor and line 76 in via holes 74 that are formed by removing an insulation film on the gate electrodes 32 and 36. The inverter 46 is thus formed. A predetermined clock signal CLK is input to the gate electrodes 32 and 36. The drain regions 40 and 42 are electrically connected to each other through a connecting conductor and line 80 in via holes 78 that are formed by removing an insulation film on the drain regions 40 and 42 and are connected to the gate electrodes 10 and 22 of the inverter 66 through a connecting conductor in a via hole (stacked via hole) 82. The predetermined driving voltage VDD is applied to the source region 38 and the source region 12 through a connecting conductor and line 92 in a via hole 90 formed by removing an insulation film on the source region 38 and through a connection conductor in a via hole 84. The source region 44 and the source region 18 are connected to the ground through a connecting conductor and line 94 in a via hole 89 formed by removing an insulation film on the source region 44 and through a connecting conductor in a via hole 86.

As thus described, in the semiconductor integrated circuit device of the present embodiment, the clock timing adjusting circuit and clocked circuit are separately formed in two layers. Output terminals of the clock timing adjusting circuit and input terminals of the clocked circuit are electrically connected through the connecting conductor in the via hole 82.

An operation of the semiconductor integrated circuit device of the present embodiment will now be described with reference to FIGS. 1 and 2. When the clock signal CLK input to the gate electrodes 32 and 36 of the inverter 46 becomes a high (H) level, the p-channel MOSFET 28 is turned off, and the n-channel MOSFET 30 is turned on. As a result, the clock signal CLK′ output from the inverter 46 becomes a low (L) level. When the clock signal CLK input to the gate electrodes 32 and 36 becomes the L level, the p-channel MOSFET 28 is turned on, and the n-channel MOSFET 30 is turned off. As a result, the clock signal CLK′ output from the inverter 46 becomes the H level. The output clock signal CLK′ is input to the inverter 66 in the lower layer. That is, the inverter 46 outputs the clock signal CLK′ having a waveform that is the inverse of the waveform of the input clock signal CLK to the inverter 66 of the FF circuit 64 through the connecting conductor in the via hole 82.

When the clock signal CLK′ input to the gate electrodes 10 and 22 of the inverter 66 becomes the H level, the p-channel MOSFET 8 and the n-channel MOSFET 6 are turned off. As a result, the clock signal CLK″ output from the inverter 66 becomes the L level. When the clock signal CLK′ input to the gate electrodes 10 and 22 of the inverter 66 becomes the L level, the p-channel MOSFET 8 is turned on, and the n-channel MOSFET 6 is turned off. As a result, the clock signal CLK″ output from the inverter 66 becomes the H level. That is, the inverter 66 outputs the clock signal CLK″ having waveform that is the inverse of the waveform of the clock signal CLK′ input thereto. The FF circuit 64 then outputs a predetermined output signal after predetermined operations are performed by other elements forming the FF circuit 64.

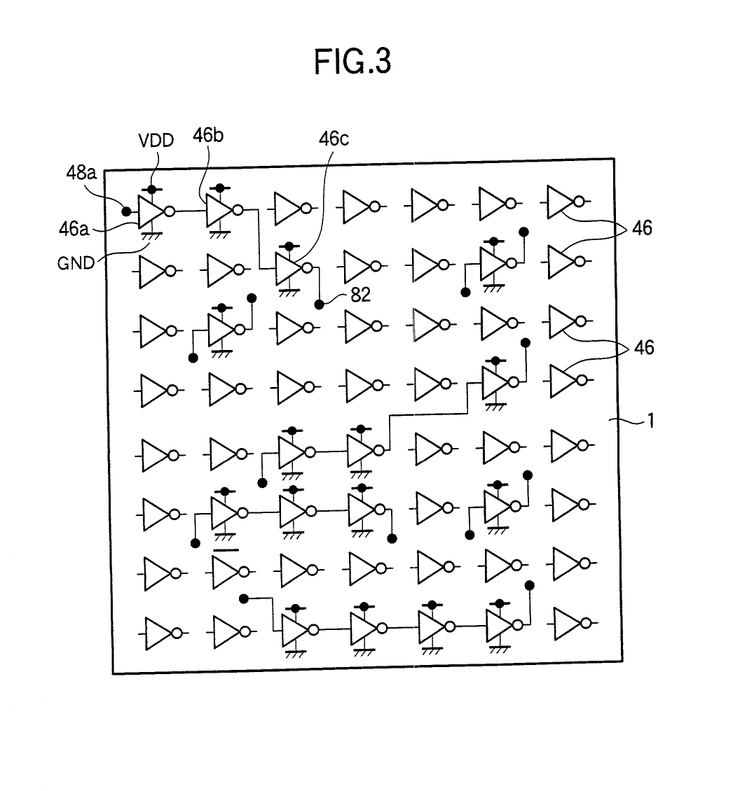

FIG. 3 is a plan view showing a configuration of inverters 46 formed in the SOI film on the layer in which the bulk CMOS is formed. As shown in FIG. 3, a plurality of the inverter 46 are uniformly arranged on an entire surface of the semiconductor chip 1 in a structure similar to the gate array structure. The inverters 46 are selectively used in combination to adjust clock skew between a plurality of clocked circuits such as the FF circuit 64 formed on the layer in which the bulk CMOS is formed. The driving voltage VDD is supplied from the layer in which the bulk CMOS is formed through the connecting conductors in the via holes 84 and 86 (which are not shown in FIG. 3). The via holes 84 and 86 may be formed for each of the inverters 46. Alternatively, one each via holes 84 and 86 may be formed to support the semiconductor chip 1 as a whole.

In the semiconductor integrated circuit device of the present embodiment shown in FIG. 3, an input terminal (not shown) for receiving an external clock signal to the semiconductor chip 1 is formed in the layer in which the bulk CMOS is formed at the bottom thereof. A clock signal line (not shown) is routed from the input terminal to the layer in which the bulk CMOS is formed. The clock signal line is extended upward from the layer in which the bulk CMOS is formed into the layer in which the SOI-CMOS is formed through a connecting conductor in a via hole 48a and is connected to an input terminal of an inverter 46a. An output terminal of the inverter 46a is connected to an input terminal of an inverter 46b. An output terminal of the inverter 46b is connected to an input terminal of an inverter 46c. An output terminal of the inverter 46c is connected to a clock input terminal of the FF circuit 64 or the like in the bottom layer in which the bulk CMOS is formed through the connecting conductor in the via hole 82. Thus, the inverters 46a, 46b, and 46c formed in an SOI structure are selectively combined to form a timing adjusting circuit to adjust clock skew between clocked circuits formed in the bottom layer in which the bulk CMOS is formed. Although not described in detail, the rest of the inverters 46 are also selectively used to adjust clock skew between clocked circuits formed in the bottom layer. The input terminal for the external clock signal may be formed in the top layer in which the SOI-CMOS is formed.

In the present embodiment, since a clock timing adjusting circuit is formed in a layer different from the layer of a clocked circuit, it is possible to avoid a change in the circuit layout as a result of the insertion of the clock timing adjusting circuit. This makes it possible to determine a layout for each circuit easily in an optimum way.

In the present embodiment, since inverters 46 are formed in a structure similar to the gate array structure, the configuration of a clock timing adjusting circuit can be changed only by changing the routing of lines to connect the inverters 46. This makes it possible to adjust clock skew easily.

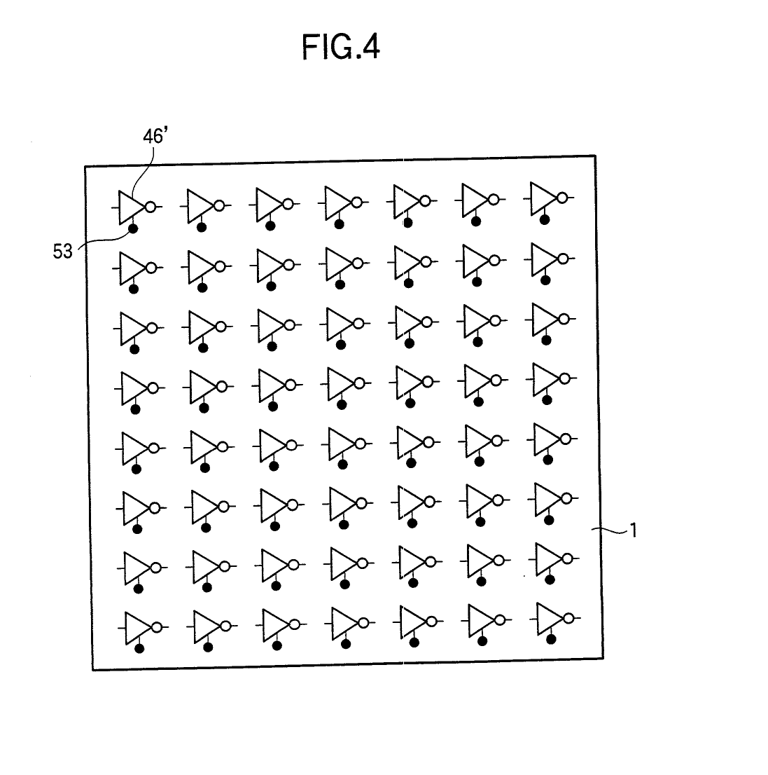

A modification of the semiconductor integrated circuit device of the present embodiment will now be described with reference to FIG. 4. FIG. 4 is a plan view similar to FIG. 3 showing a configuration of inverters 46′ formed in the SOI film on the layer in which the bulk CMOS is formed. The present modification is characterized in that each of a plurality of inverters 46′ formed in a structure similar to the gate array structure has a terminal 53 for adjusting a delay time. A delay time of a clock signal CLK in an inverter 46′ can be changed by inputting a predetermined external signal to the delay time adjusting terminal 53 after the semiconductor chip 1 is completed. The delay time of the clock signal CLK in the inverter 46′ can be changed in various ways such as switching a selector using a laser beam.

In addition to the same effect as that of the above-described embodiment, the present modification makes it possible to reduce a turn-around time (TAT) in the case of an engineering change order (ECO) because clock skew can be adjusted after the semiconductor chip 1 is completed.

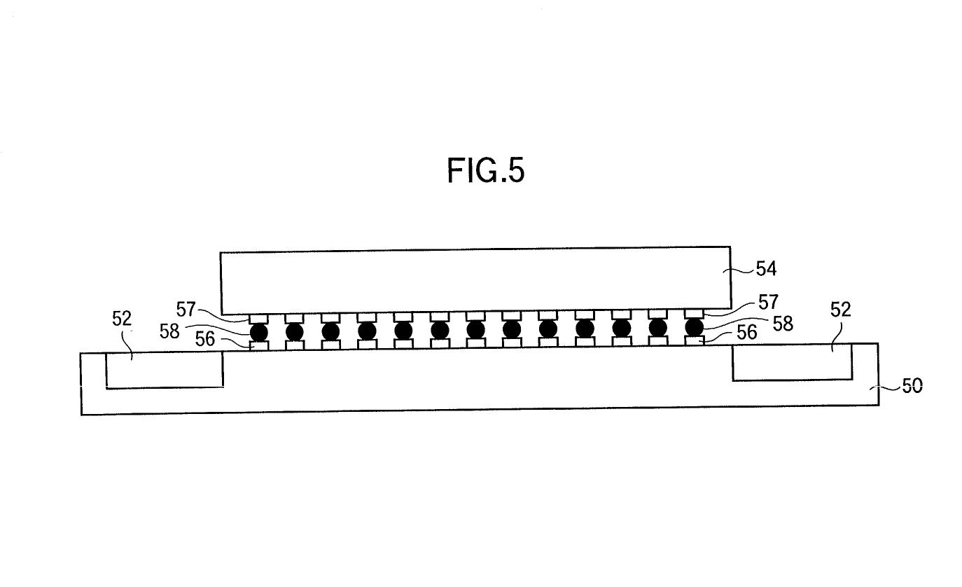

Semiconductor integrated circuit device according to a second embodiment of the invention will now be described with reference to FIGS. 5 through 9. FIG. 5 is a sectional view showing a configuration of the semiconductor integrated circuit device of the present embodiment. As shown in FIG. 5, clocked circuits (not shown) are formed on a top surface of a lower semiconductor chip 50 in FIG. 5. A plurality of electrode terminals 56 in a matrix-like configuration are formed on a bottom surface of the semiconductor chip 50. A timing adjusting circuit (not shown) constituted by a plurality of inverters 46 arranged similarly to those in FIG. 3 is formed on a top surface of an upper semiconductor chip 54 in FIG. 5. A plurality of electrode terminals 57 arranged similarly to the electrode terminals 56 are formed on a bottom surface of the semiconductor chip 54. The inverters 46 of the timing adjusting circuit formed on the top surface of the semiconductor chip 54 may have a delay time adjusting terminal 53 similarly to the inverters 46′ shown in FIG. 4. The inverters 46 are selectively used in combination to adjust clock skew between the clocked circuits formed on the top surface of the semiconductor chip 50. The bottom sides of the semiconductor chips 50 and 54 are electrically connected to each other and combined through a plurality of bumps 58 which connects the plurality of electrode terminals 56 and 57 respectively (chip-on-chip method). Wiring pads 52 for external input and output are provided at the periphery of the semiconductor chip 50.

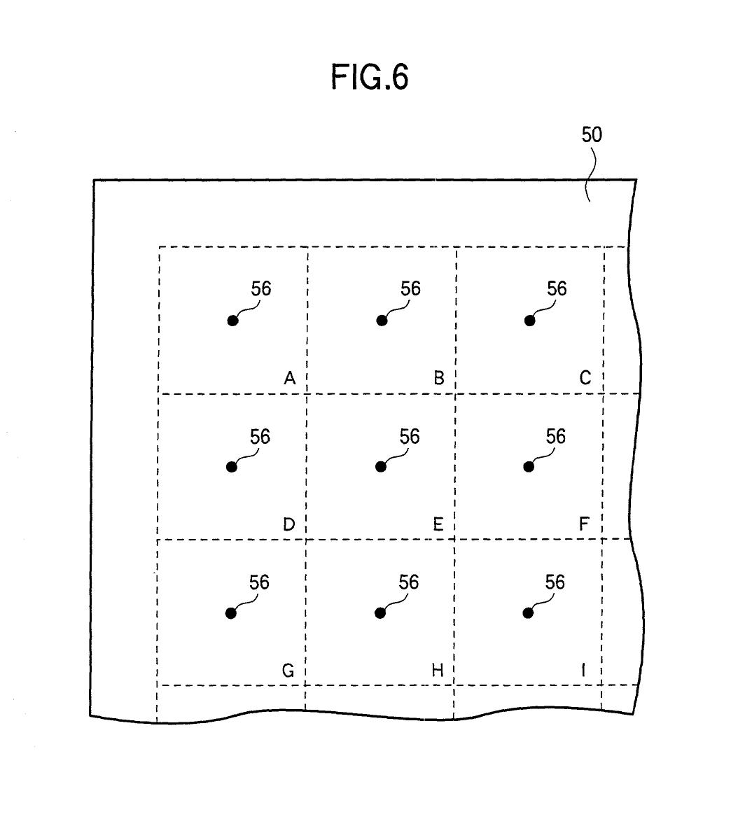

FIG. 6 is a plan view showing the configuration of the semiconductor chip 50 of the semiconductor integrated circuit device shown in FIG. 5. As shown in FIG. 6, the plurality of electrode terminals 56 are formed at intervals of 0.5 mm, for example, in the form of a matrix on the bottom surface of the semiconductor chip 50. The semiconductor chip 50 has a plurality of grid-like divisions each of which is associated with an electrode terminal 56 as indicated by the imaginary lines represented by broken lines in the figure (FIG. 6 shows divisions A through I arranged in the form of a 3×3 matrix). Each of the clocked circuits formed on the semiconductor chip 50 is included in any of the divisions.

Although not shown, in each of the divisions A through H of the semiconductor chip 50, the clocked circuits are provided such that clock signal lines extending from the electrode terminals 56 to the clock input terminals of the clocked circuits have equal line lengths to adjust clock skew. The clocked circuits can be relatively easily laid out because it is only required to adjust clock skew in each of the small divisions A through H.

In the semiconductor integrated circuit device of the present embodiment, an external clock signal is input from predetermined wiring pads 52 of the semiconductor chip 50 and is supplied to the semiconductor chip 54 through predetermined electrode terminals 56 and bumps 58. The clock timing adjusting circuit formed on the top surface of the semiconductor chip 54 is configured such that it adjusts clock skew between the electrode terminals 57 that are associated with the plurality of electrode terminals 56 on the semiconductor chip 50 through the bumps 58. For example, the clock timing adjusting circuit adjusts clock skew between the clocked circuits in each of the divisions A through H based on loads such as the line lengths of the clock signal lines beyond the electrode terminals 56 and the number of the clocked circuits. In order to make the loads in the divisions A through H equal, dummy loads may be provided in the divisions A through H except the division having the greatest load such that the loads are adjusted to the greatest load.

In the present embodiment, since the clock timing adjusting circuit is formed on the semiconductor chip 54 that is different from the semiconductor chip 50 in which the clocked circuits are formed, it is possible to suppress changes in the circuit layout as a result of the insertion of the clock timing adjusting circuit just as in the first embodiment. This makes it possible to determine a layout for each circuit easily in an optimum way.

In the present embodiment, it is also possible to change the configuration of the clock timing adjusting circuit by only changing the routing of the lines connecting the inverters 46 or the like because the plurality of inverters 46 in the semiconductor chips 54 are formed in a structure similar to the gate array structure. This makes it possible to adjust clock skew between clocked circuits easily.

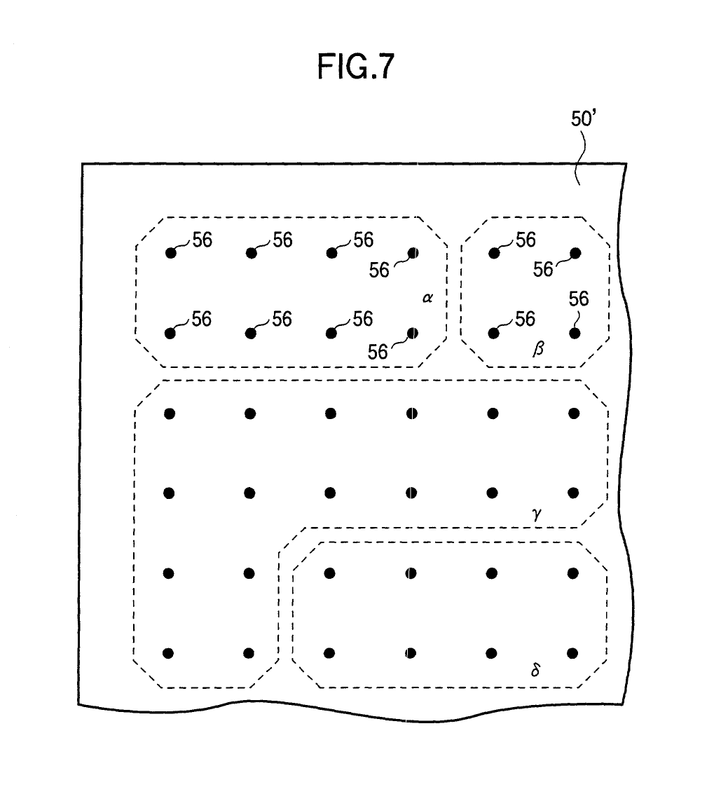

FIG. 7 shows a modification of the semiconductor integrated circuit device of the present embodiment. In the present modification, unlike the semiconductor chip 50 shown in FIG. 6, a semiconductor chip 50′ has a plurality of divisions each of which is associated with a functional block having a predetermined function, e.g., a control unit or arithmetic unit (FIG. 7 shows divisions α through β that are divided by the imaginary lines represented by broken lines). For example, the division α has eight electrode terminals 56. A clock timing adjusting circuit formed on a semiconductor chip (not shown) that is combined with the semiconductor chip 50′ adjusts clock skew between electrode terminals 57 each of which is associated with any of the electrode terminals 56 in the divisions α through δ through the bump 58.

In the present modification, there is provided divisions a through δ each of which is associated with a functional block. Therefore, when there is no need for causing clocked circuits to operate in synchronism between functional blocks having different functions, it is not necessary to adjust clock skew between the functional blocks. This further facilitates the adjustment of clock skew.

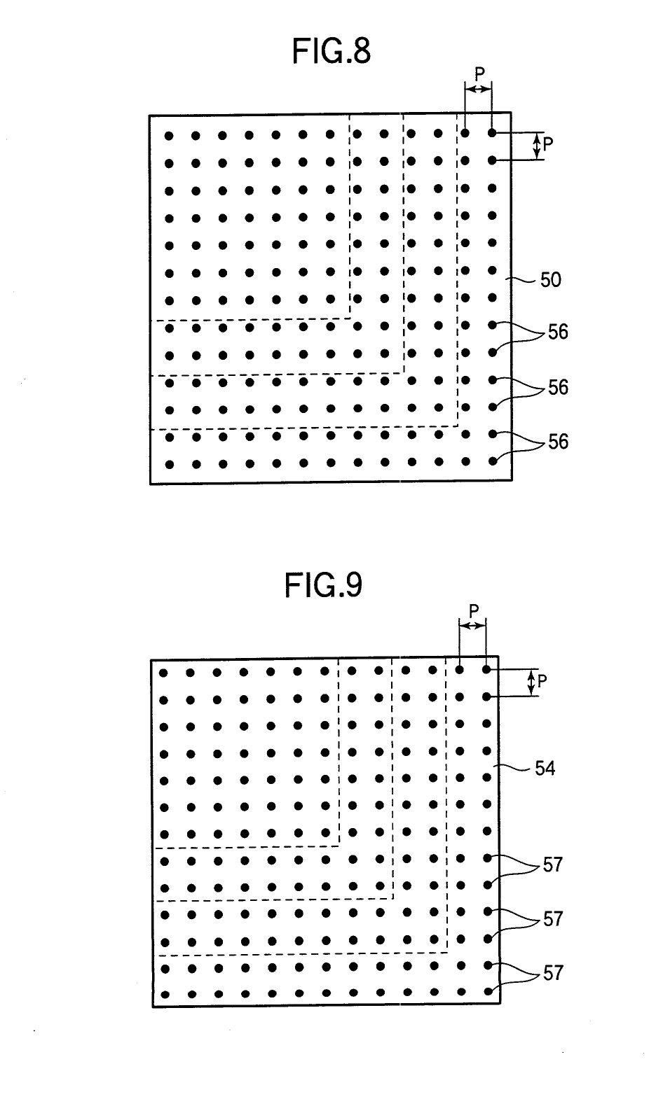

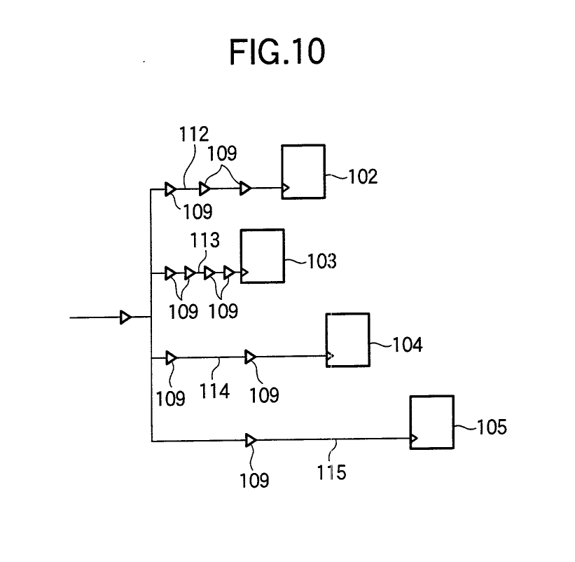

FIG. 8 shows another modification of the semiconductor integrated circuit device of the present embodiment. As shown in FIG. 8, a semiconductor chip 50 in which clocked circuits and the like are formed is in a substantially square configuration and may be formed in four different sizes as indicated by broken lines in the figure, for example. Electrode terminals 56 are provided at predetermined standardized intervals P (e.g., 0.5 mm).

FIG. 9 shows a configuration of a semiconductor chip 54 that is combined with the semiconductor chip 50. The semiconductor chip 54 is in a configuration substantially similar to that of the semiconductor chip 50 and may be formed in four different sizes as indicated by broken lines in the figures. Electrode terminals 57 are provided at the same intervals P (e.g., 0.5 mm) as those between the electrode terminals 56.

In the present modification, the electrode terminals 56 formed in the semiconductor chip 50 and the electrode terminals 57 formed in the semiconductor chip 54 are provided at the standardized intervals P. Further, a plurality of inverters (not shown in FIG. 9) that form a clock timing adjusting circuit are formed in a structure similar to the gate array structure in the semiconductor chip 54, which makes it possible to change the configuration of the clock timing adjusting circuit by only changing the routing of lines connecting the inverters and the like. Thus, the semiconductor chip 54 for a clock timing adjusting circuit can be used as a general-purpose component with various types of semiconductor chips 50. Further, when it is required to adjust clock skew only in a part of a semiconductor chip 50, a semiconductor chip 54 smaller than the semiconductor chip 50 may be used.

The present invention is not limited to the above-described embodiments and may be modified in various ways.

For example, although a plurality of inverters that form a clock timing adjusting circuit are formed in a uniform arrangement in a structure similar to the gate array structure in the above-described embodiments, this is not limiting the present invention. Obviously, a clock timing adjusting circuit may be formed with a limited number of inverters that are required for adjusting clock skew between clocked circuits.

In the above-described embodiments, clocked circuits are formed in a layer in which a bulk CMOS is formed, and a clock timing adjusting circuit is formed in a Layer in which an SOI-CMOS is formed. However, this is not limiting the invention. Obviously, a clock timing adjusting circuit may be formed in a layer in which a bulk CMOS is formed, and clocked circuits may be formed in a layer in which an SOI-CMOS is formed.

As described above, according to the invention, it is possible to determine a layout for an LSI circuit easily in an optimum way.

What is claimed is

1. A semiconductor integrated circuit device comprising:
a clocked circuit formed on a substrate and operating in synchronism with a clock signal; and
a clock timing adjusting circuit formed in a layer that is different from the layer in which the clocked circuit is formed.

2. A semiconductor integrated circuit device according to claim 1, wherein the clock timing adjusting circuit is provided in an SOI film formed on the substrate.

3. A semiconductor integrated circuit device according to claim 2, further comprising a via hole for electrically connecting the clock timing adjusting circuit and the clocked circuit.

4. A semiconductor integrated circuit device according to claim 3, wherein the clock timing adjusting circuit has a plurality of inverters.

5. A semiconductor integrated circuit device according to claim 4, wherein the inverters are uniformly arranged.

6. A semiconductor integrated circuit device according to claim 4, wherein the inverters have a terminal for adjusting a delay time capable of adjusting a delay time.

7. A semiconductor integrated circuit device comprising:
a clocked circuit formed on a top surface of a first semiconductor chip and operating in synchronism with a clock signal;
a first electrode terminal formed on a bottom surface of the first semiconductor chip;
a clock timing adjusting circuit formed on a top surface of a second semiconductor chip;
a second electrode terminal formed on a bottom surface of the second semiconductor chip; and
bumps formed between the first and second electrode terminals to combine the first and second semiconductor chips.

8. A semiconductor integrated circuit device according to claim 7, wherein the first semiconductor chip has a plurality of divisions and wherein clock skew is adjusted in each of the divisions.

9. A semiconductor integrated circuit device according to claim 8, wherein the divisions are formed in association with respective bumps.

10. A semiconductor integrated circuit device according to claim 8, wherein the divisions are formed in association with respective functional blocks having predetermined functions.

11. A semiconductor integrated circuit device according to claim 7, wherein the clock timing adjusting circuit has a plurality of inverters.

12. A semiconductor integrated circuit device according to claim 11, wherein the inverters are uniformly arranged.

13. A semiconductor integrated circuit device according to claim 7, wherein the inverters have a terminal for adjusting a delay time capable of adjusting a delay time.

14. A semiconductor integrated circuit device according to claim 7, wherein the bumps are provided at predetermined intervals.

15. A semiconductor integrated circuit device according to claim 1, wherein the clocked circuit is a macro and sequential circuit.

16. A method of distributing a clock in a semiconductor integrated circuit, comprising the step of providing a clock timing adjusting circuit for a clocked circuit formed on a silicon substrate and operating in synchronism with a clock signal after a wiring step in processing a wafer.

17. A method of distributing a clock in a semiconductor integrated circuit according to claim 16, wherein the clock timing adjusting circuit is formed using an SOI structure on the clocked circuit that is formed on a silicon substrate.

18. A method of distributing a clock in a semiconductor integrated circuit according to claim 17, wherein a layer exclusively used for wiring is provided for electrically connecting the clock timing adjusting circuit and the clocked circuit.
